(19) United States
(12) Patent Application Publication
(10) Pub. No.: US 2025/0365445 A1
(43) Pub. Date: Nov. 27, 2025

(54) BITSTREAM STRUCTURE IN VIDEO CODING FOR MACHINE

(71) Applicant: Tencent America LLC, Palo Alto, CA (US)

(72) Inventors: Ding DING, Washington, DC (US); Roman CHERNYAK, Santa Clara, CA (US); Shan LIU, San Jose, CA (US)

(73) Assignee: Tencent America LLC, Palo Alto, CA (US)

(21) Appl. No.: 19/188,460

(22) Filed: Apr. 24, 2025

Related U.S. Application Data
(60) Provisional application No. 63/651,666, filed on May 24, 2024.

(51) Int. Cl. H04N 19/65; H04N 19/70; H04N 19/88

(52) U.S. Cl. CPC H04N 19/65; H04N 19/70; H04N 19/88

(57) ABSTRACT

An aspect of the disclosure provides a method of video decoding. For example, a bitstream is received. The bitstream includes coded information of a video for a machine task, the coded information includes a first portion and a second portion that are interleaved, the first portion is coded according to a video coding standard, and the second portion includes restoration data for the machine task. The coded information is reordered to generate a sub stream of the bitstream having the first portion. First reconstructed pictures of the video are generated from the sub stream according to the video coding standard. The restoration data is determined from the second portion. Second reconstructed pictures for the machine task are generated based on the first reconstructed pictures and the restoration data.

### INCORPORATION BY REFERENCE

The present application claims the benefit of priority to U.S. Provisional Application No. 63/651,666, filed on May 24, 2024. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

An aspect of the disclosure provides a method of video decoding. For example, a bitstream is received. The bitstream includes coded information of a video for a machine task, the coded information includes a first portion and a second portion that are interleaved, the first portion is coded according to a video coding standard, and the second portion includes restoration data for the machine task. The coded information is reordered to generate a sub stream of the bitstream having the first portion. First reconstructed pictures of the video are generated from the sub stream according to the video coding standard. The restoration data is determined from the second portion. Second reconstructed pictures for the machine task are generated based on the first reconstructed pictures and the restoration data.

Another aspect of the disclosure provides a method of video encoding. For example, coded information of a video is generated according to a video coding standard. Restoration data for generating reconstructed pictures for a machine task from the coded information of the video is determined. The coded information of the video is interleaved with the restoration data to form a bitstream.

Another aspect of the disclosure provides a method of processing visual media data is provided. In the method, a conversion between a visual media file and a bitstream of visual media data is performed according to a format rule. In an example, the bitstream carries coded information of a video for a machine task, the coded information includes a first portion and a second portion that are interleaved, the first portion is coded according to a video coding standard, and the second portion includes restoration data for the machine task. The format rule specifies that: the coded information is reordered to generate a sub stream of the bitstream having the first portion; first reconstructed pictures are generated from the sub stream according to the video coding standard; the restoration data is determined from the second portion; and second reconstructed pictures are generated for the machine task based on the first reconstructed pictures and the restoration data.

Aspects of the disclosure also provide an apparatus for video encoding. The apparatus for video encoding includes processing circuitry configured to implement any of the described methods for video encoding.

Aspects of the disclosure also provide an apparatus for video decoding. The apparatus for video decoding includes processing circuitry configured to implement any of the described methods for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a block diagram of a video processing system in a machine scenario in some examples.

FIG. 5 shows a syntax table of SPS in VVC in some examples.

FIG. 6 shows a syntax table of a picture header in VVC in some examples.

FIG. 7 shows a syntax table of an end of bitstream (EOB) in VVC in some examples.

FIG. 8 shows a diagram of a bitstream structure according to some aspects of the disclosure.

FIG. 9 shows a diagram of a bitstream structure according to some aspects of the disclosure.

FIG. 10 shows a diagram of a syntax table at a sequence level in an NAL unit in some examples.

FIG. 11 shows a diagram of a syntax table at a frame level in an NAL unit in some examples.

FIG. 12 shows a diagram of a syntax table at an EOB in an NAL unit in some examples.

FIG. 13 shows a syntax table of a VCM unit in some examples.

FIG. 14 shows a syntax table of a header container in a VCM unit in some examples.

FIG. 15 shows a syntax table of a payload container in a VCM unit in some examples.

FIG. 16 shows a syntax table of restoration data container in some examples.

FIG. 17 shows a syntax table for a sub-stream header in some examples.

FIG. 18 shows a syntax table for a sub-stream NAL unit in some examples.

FIG. 19 shows a syntax table for a VCM NAL unit in some examples.

FIG. 20 shows a syntax table for sequence restoration data RBSP in some examples.

FIG. 21 shows a syntax table for picture restoration data RBSP in some examples.

FIG. 22 shows a flow chart outlining a process according to an aspect of the disclosure.

FIG. 23 shows a flow chart outlining a process according to an aspect of the disclosure.

FIG. 24 is a schematic illustration of a computer system in accordance with an aspect.

### DETAILED DESCRIPTION

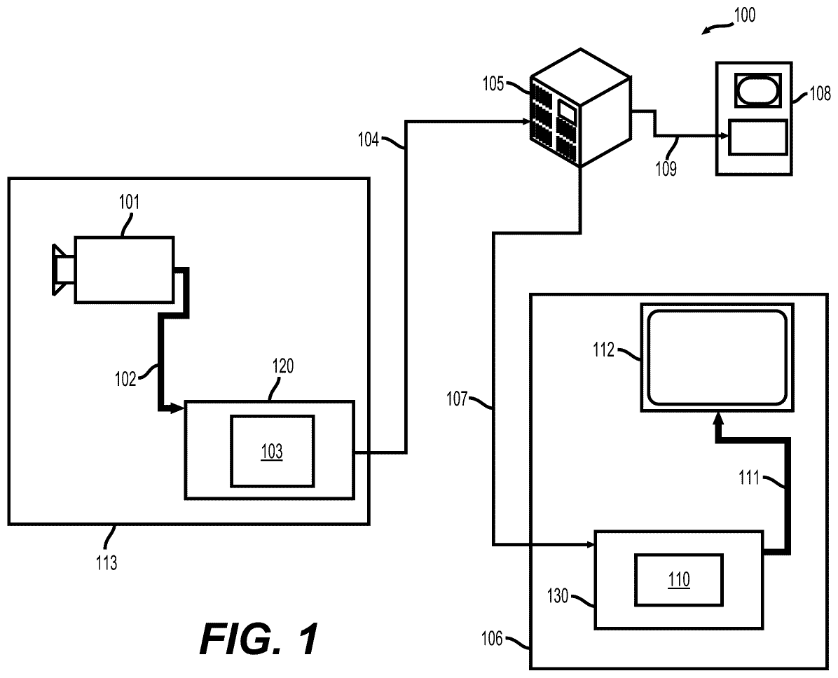

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

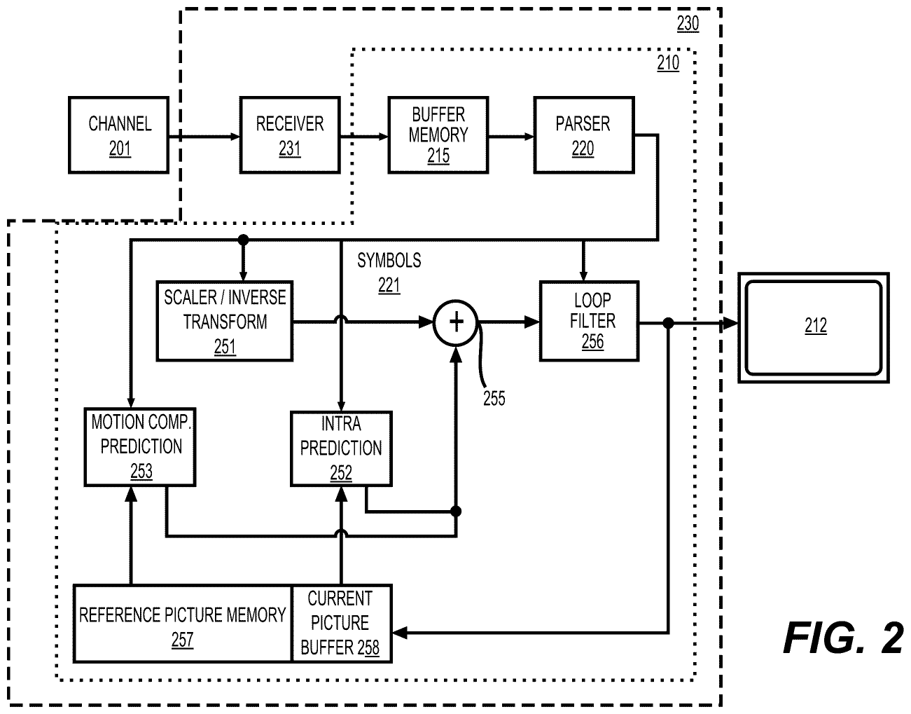

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. A Iso necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

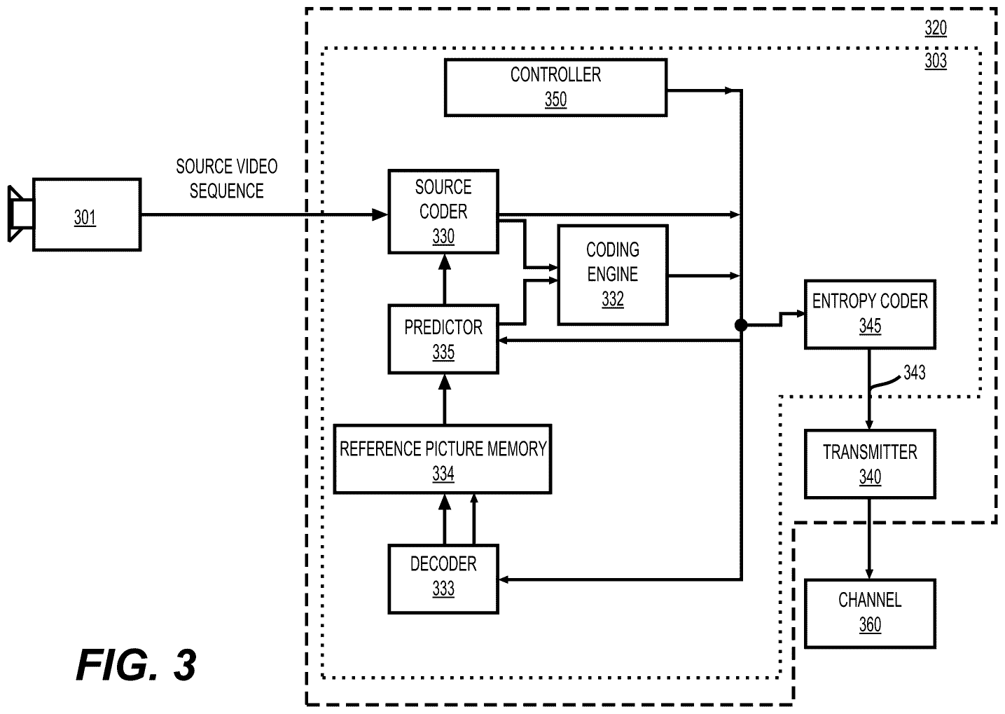

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 YCrCB, RGB, . . . ), and any suitable sampling structure (for example YCrCb 4:2:0, YCrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

According to some aspects of the disclosure, video coding can be used in machine scenarios.

FIG. 4 shows a block diagram of a video processing system (400) in a machine scenario in some examples. In the FIG. 4 example, the video processing system (400) includes a plurality of video sources for machine consumption. For example, the video processing system (400) includes a camera (401) coupled to an encoder device (402).

In some examples, an encoder can be optimized for machine consumption. For example, the encoder device (402) is optimized for encoding bitstreams for machine consumption. For example, the encoder device (402) is coupled, via a network (403), to a decoder device (404), and the decoder device (404) is coupled to a machine (405) that consumes the decoded video (e.g., perform further analysis, detection, and the like on the video). Thus, an encoded bitstream can be provided from the encoder device (402) to the decoder device (404) via the network (403), and the encoded bitstream can be decoded by the decoder device (404), and the decoded video data can be further processed by the machine (405).

Video compression can be used for not only human but also machine consumptions. Video coding for machine (VCM) can be standardized to be a portion of some standards, such as ISO/IEC JTC 1 SC 29 WG 4. In some examples, VCM's reference model can use a related video coding standard (e.g., a related video coding standard for human consumption) as the core codec. In certain environments, such as in video coding for consumption by machines (in contrast to humans), the requirement for a bitstream to pass a quality threshold based on human perception may not be required. Instead, the quality can be sufficient for machine consumption even if not adequate for human consumption. However, the related video coding standard is primarily standardized for video application served for human vision. In some examples, several coding tools in the related video coding standards are identified as not be beneficial for machine tasks, but can potentially increase complexity, such as encoding/decoding time.

Some aspects of the present disclosure provide techniques of bitstream structures for VCM, for example including bitstream structures for information signaling, coding and parsing in video coding systems. It is noted that the techniques used for VCM can be used in general video coding systems in some examples. In some examples, encoder can generate and send a bitstream to a decoder. The bitstream includes coded information of a video for a machine task, the coded information includes a first portion and a second portion that are interleaved, the first portion is coded according to a video coding standard, and the second portion includes restoration data for the machine task. A sub stream of the bitstream having the first portion can be generated by reordering. First reconstructed pictures of the video can be generated from the sub stream according to the video coding standard. The restoration data can be determined from the second portion. Second reconstructed pictures for the machine task can be generated based on the first reconstructed pictures and the restoration data.

It is noted when a related video coding standard is used in the present disclosure, the related video coding standard can include, but not limited to audio video standard (AVS) 1, AVS 2, AVS 3, AVS 4, advanced video coding (AVC), high efficiency video coding (HEVC), versatile video coding (VVC), alliance for open media (AOMedia) video 1 (AV1), AV 2, and the like.

In some aspects, the VCM related information can be sequence-level information that is signaled, transmitted, and parsed at the sequence level. In some aspects, the VCM related information is only frame-level information that is signaled, transmitted, and parsed at the frame level. In some aspects, the VCM related information can include sequence-level information and frame-level information that are signaled, transmitted, and parsed at the sequence level and the frame level.

In some aspects, the VCM related information can include sequence-level information and/or frame-level information that is signaled, transmitted, and parsed via SEI message based on related video coding standard, such as VVC.

In some aspects, the VCM related information is embedded into a structure of a related video coding standard, the structure of the related video coding standard can include but not limit to a sequence parameter set (SPS), a picture parameter set (PPS), a picture header (PH) and a slice header (SH).

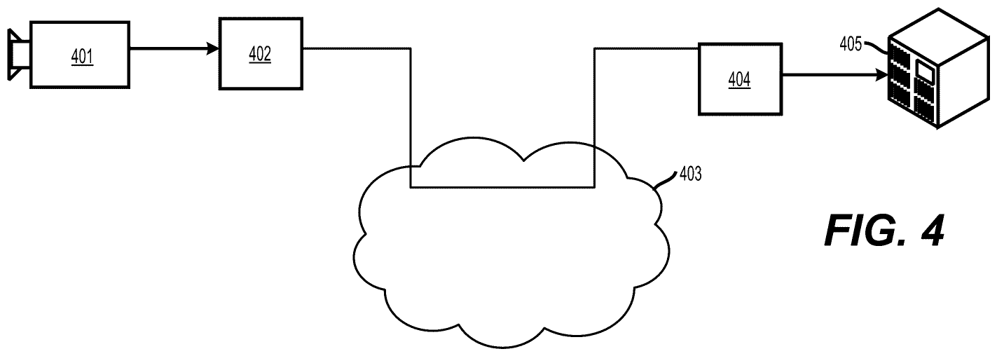

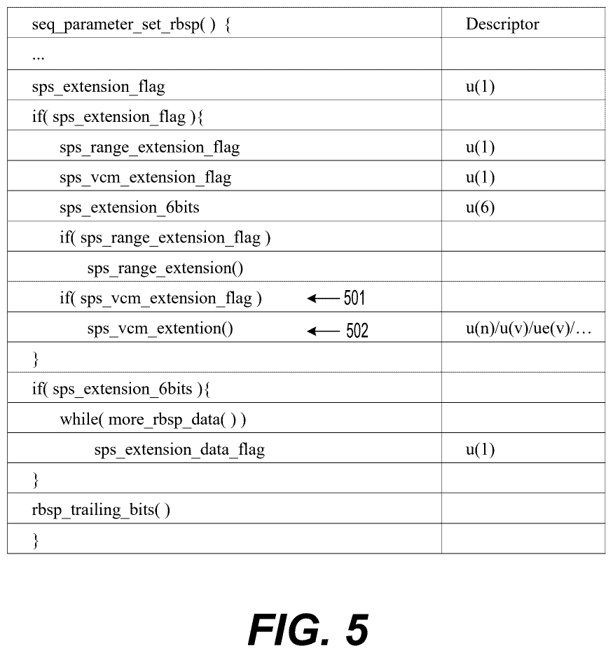

FIG. 5 shows a syntax table of SPS in VVC in some examples. The VCM related information can be included at the SPS level as an extension that is a sequence level container to include the VCM related information, such as temporal resample, bit depth truncation, and the like. In some examples, the extension of the VCM related information can include modules of, for example, region of interest (Rol), bit depth truncation and the like.

In the FIG. 5 example, a VCM extension flag (e.g., sps_vcm_extension_flag) is signaled in a bitstream to indicate whether VCM related information is included in an extension at the SPS level, such as shown by (501). As shown by (502) in FIG. 5, when the VCM extension flag is true, an extension (e.g., sps_vcm_extention( )) is included at the SPS level to include VCM related information. VCM related information at the SPS level can be decoded from the VCM extension in the bitstream.

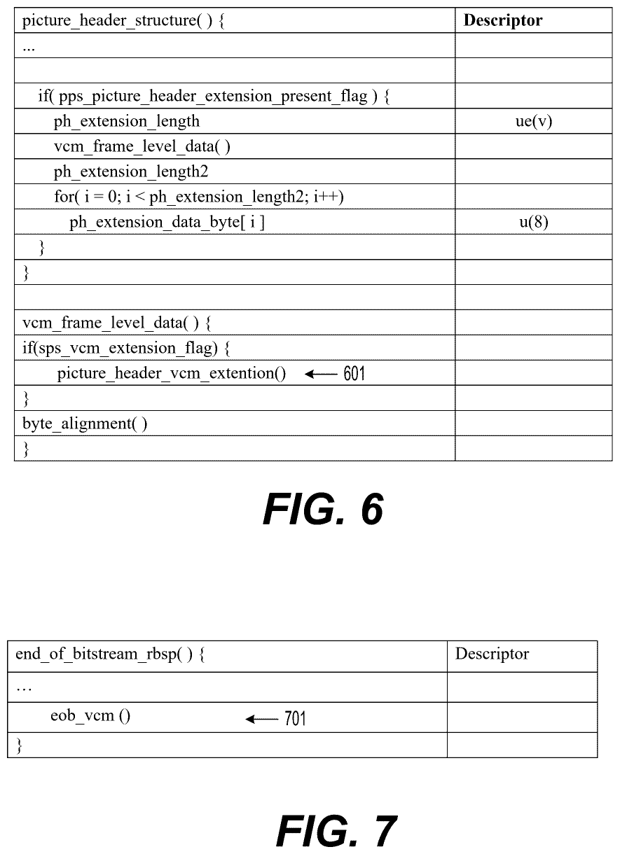

FIG. 6 shows a syntax table of a picture header in VVC in some examples. The VCM related information can be included at frame level in the picture header as an extension that is a frame level container to include the VCM related information, such as temporal resample, bit depth truncation, and the like that can be used for restoration.

In the FIG. 6 example, the VCM extension flag (e.g., sps_vcm_extension_flag) is true, an extension (e.g., picture_header_vcm_extention( )) is included at the frame header level to include VCM related information, such as shown by (601) in FIG. 6. VCM related information at the frame header level can be decoded from the VCM extension in the bitstream.

FIG. 7 shows a syntax table of an end of bitstream (EOB) in VVC in some examples. The VCM related information can be included in the EOB as an extension at a sequence level to include the VCM related information, such as temporal resample, bit depth truncation, and the like that can be used for restoration.

In the FIG. 7 example, a container (e.g., eob_vcm( )) is included at the sequence level at the end of the bitstream to include VCM related information, such as shown by (701) in FIG. 7. In an example, when the bitstream is generated for video streaming, the restoration information at the end of the video can be different from within the video, and the related VCM information for restoration at the end of the bitstream can be included in the container in the EOB.

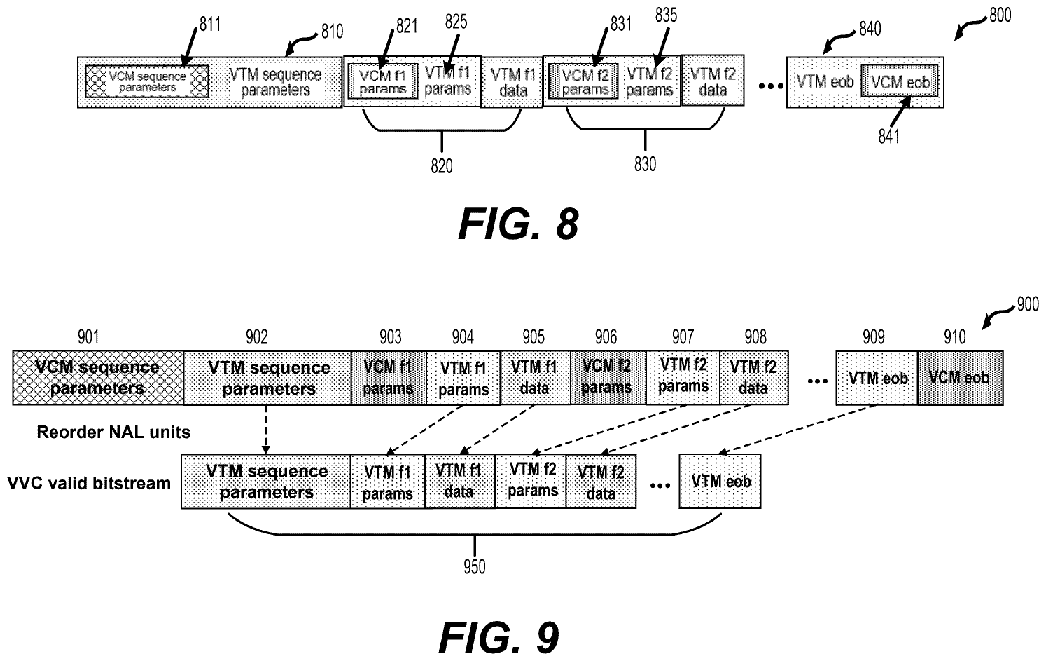

FIG. 8 shows a diagram of a bitstream structure (800) according to some aspects of the disclosure. The bitstream structure (800) is formed according to a related video coding standard with the VCM related information embedded into the bitstream structure (800) by extensions, such as using the syntax tables in FIGS. 5-7. In the FIG. 8 example, the related video coding standard is VVC test model (VTM).

For example, the bitstream structure (800) includes sequence level parameters, such as VTM sequence parameters (810) and VTM end of bitstream (EOB) (840). The bitstream structure (800) also includes a plurality of frame data, such as a first frame (f1) (820) and a second frame (f2) (830).

In the FIG. 8 example, the bitstream structure (800) includes sequence level VCM related information, such as VCM sequence parameters (811) that are embedded into the VTM sequence parameters (810), VCM EOB (841) that is embedded into the VTM EOB (840). The bitstream structure (800) also includes frame level VCM related information, such as VCM frame1 (f1) parameters (821) that is embedded in the VTM frame1 (f1) parameters (825), VCM frame2 (f2) parameters (831) that is embedded in the VTM frame2 (f2) parameters (835).

According to some aspects of the disclosure, VCM related structures (e.g., sequence level VTM related structures, and/or frame level VTM related structures) are interleave with structures of a related video coding standard.

In some aspects, a bitstream (e.g., referred to as VCM bitstream) includes a plurality of structures (also referred to as VCM units in some examples), some structures (e.g., referred to as first structures) include VCM related information and some structures (e.g., referred to as second structures) include video information of a related video coding standard. The first structures and the second structures can be interleaved in the bitstream. In some examples, each structure of the plurality of structures can include information that indicates the type of the structure. Thus, the structures in the bitstream can be suitably parsed, organized, and decoded.

In some examples, a bitstream is transmitted in network abstraction layer (NAL) units. For example, on the encoder side, NAL units are generated at the network abstraction layer. An NAL unit includes a header with information identifying the NAL unit. The NAL units can be transferred, for example respectively over a network, as one piece. On the decoding side, the NAL units are received (e.g., from a network) and passed to the decoder. In some examples, some NAL units (also referred to as first NAL units) include VCM related information, and some NAL units (also referred to as second NAL units) include information of a related video coding standard, such as video data according to VVC. The first NAL units and the second NAL units can be interleaved in the bitstream.

In some examples, at the decoder side, when parsing a bitstream, the NAL units can be reordered and separated into sub streams. For example, the VCM related information and the information of the related video coding standard are separated into a first sub stream, and a second sub stream respectively. The first sub stream and the second sub stream can be parsed separately. In some examples, the first sub stream which includes VCM related information can be parsed by the VCM decoder, and the second sub stream which includes the information of the related video coding standard (e.g., VVC) can be parsed according to the related video coding standard.

FIG. 9 shows a diagram of a bitstream structure (900) according to some aspects of the disclosure. In the FIG. 9 example, the VCM related information is interleaved with information of a related video coding standard, such as VVC test model (VTM) in the bitstream structure (900).

In the FIG. 9 example, the VCM related information is interleaved with information of VTM. For example, the bitstream structure (900) includes portions (901)-(910), some portions, such as the portions (901), (903), (906) and (910) are VCM related information; and some portions, such as portions (902), (904), (905), (907), (908) and (909) are VTM related information. It is noted that a portion in the FIG. 9 example can be included in one or more NAL units.

In the FIG. 9 example, NAL units can be re-ordered into sub streams. For example, the NAL units that correspond to the portions (902), (904), (905), (907), (908) and (909) are reordered into a sub stream (950). The sub stream (950) can be parsed and decoded according to VVC. Not shown in FIG. 9, the VCM related portions can be reordered and parsed using the VCM decoder.

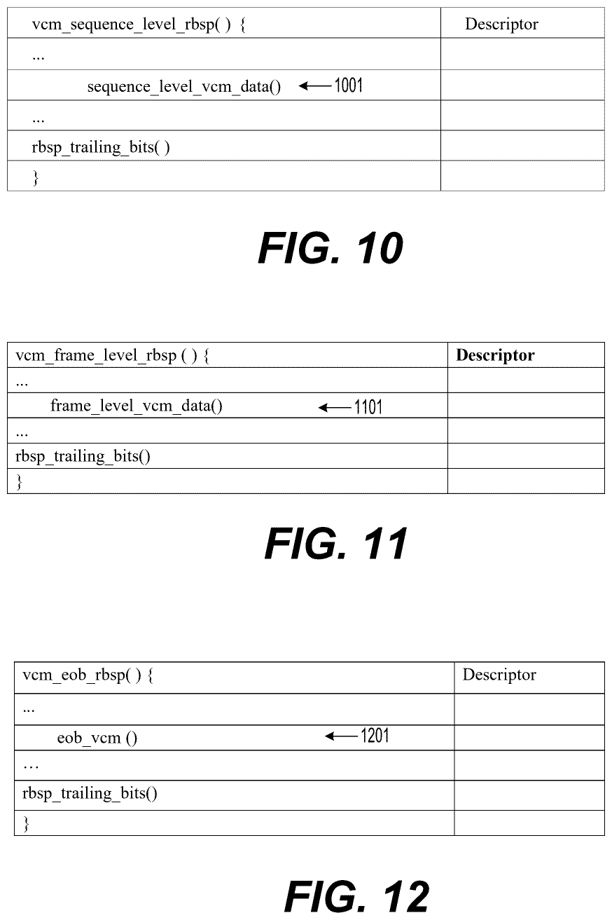

FIG. 10 shows a diagram of a syntax table at a sequence level in an NAL unit in some examples. The syntax table in FIG. 10 is configured to include VCM sequence parameters. For example, a container (e.g., sequence_level_vcm_data( )) (1001) is a sequence level container that includes VCM related information, such as temporal resample, bit depth truncation, and the like.

FIG. 11 shows a diagram of a syntax table at a frame level in an NAL unit in some examples. The syntax table in FIG. 11 is configured to include VCM frame parameters. For example, a container (e.g., frame_level_vcm_data( )) (1101) is a frame level container that includes VCM related information, such as temporal resample, bit depth truncation and the like.

FIG. 12 shows a diagram of a syntax table at an EOB in an NAL unit in some examples. The syntax table in FIG. 12 is configured to include VCM end-of-bitstream information. For example, a container (e.g., eob_vcm_extention( )) (1201) is a sequence level container that includes VCM related information, such as temporal resample, bit depth truncation and the like.

In some examples, a plurality of types of VCM units are used. For example, the plurality of types include a first type that is referred to as VCM parameter set (e.g., denoted by VCM_VPS), a second type that is referred to as restoration data (e.g., denoted by VCM_RSD), and a third type that is referred to as coded video data (e.g., denoted by VCM_CVD). The first type and the second type of VCM units include VCM related information. The third type of VCM units include the information of the related video coding standard. In some examples, a bitstream can include a VCM unit of VCM_VPS type, one or more VCM units of VCM_RSD type, and one or more VCM units of VCM_CVD type.

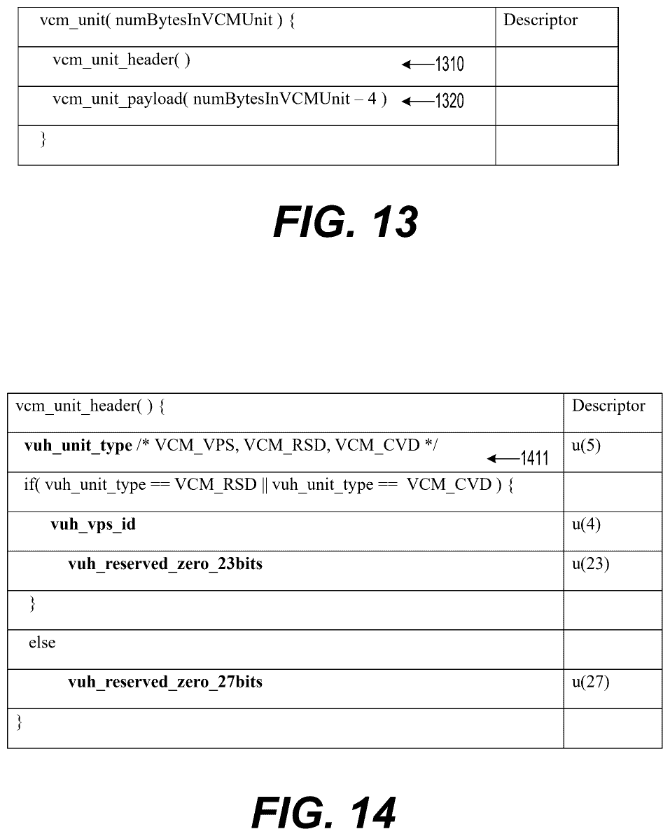

In some examples, a VCM unit includes a header and a payload. FIG. 13 shows a syntax table of a VCM unit in some examples. The VCM unit includes a header container (1310) and a payload container (1320).

In some examples, the header container includes a syntax element identifying the type of the VCM unit. FIG. 14 shows a syntax table of a header container in a VCM unit in some examples. The header container includes a syntax element identifying a type of the VCM unit, such as shown by (1411).

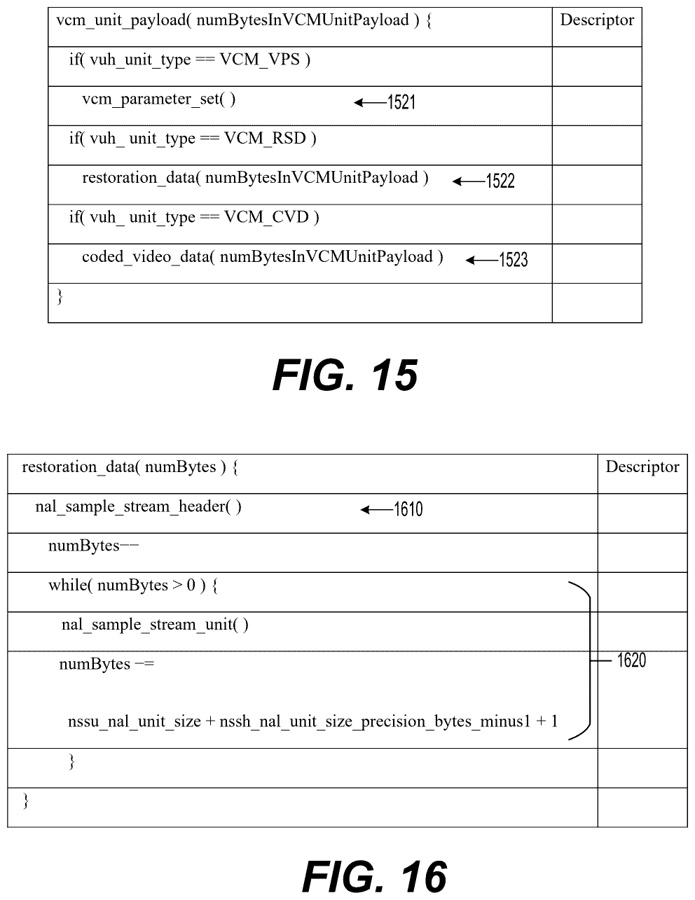

In some examples, the payload container includes different containers for different types of VCM units. FIG. 15 shows a syntax table of a payload container in a VCM unit in some examples. The payload container includes a VCM parameter set container (1521) when the type of the VCM unit is VCM_VPS. The payload container includes a restoration data container (1522) when the type of the VCM unit is VCM_RSD. The payload container includes a coded video data container (1523) when the type of the VCM unit is VCM_CVD.

The VCM parameter set container can include high level parameters, such as control flags, and the like. The restoration data container can include information to enable restoration for VCM. The coded video data container can include a (sub) stream of video data according to a related standard, such as VVC, HEVC, and the like.

In some examples, the restoration data container can include a sub stream of information for restoration. FIG. 16 shows a syntax table of restoration data container in some examples. The restoration data container includes a sub stream header, such as shown by (1610), and a plurality of sub stream NAL units, such as shown by (1620). In an example, the sub stream header includes information at the sub stream level, such as precision information in an example. The plurality of sub stream NAL units respectively include VCM NAL unit.

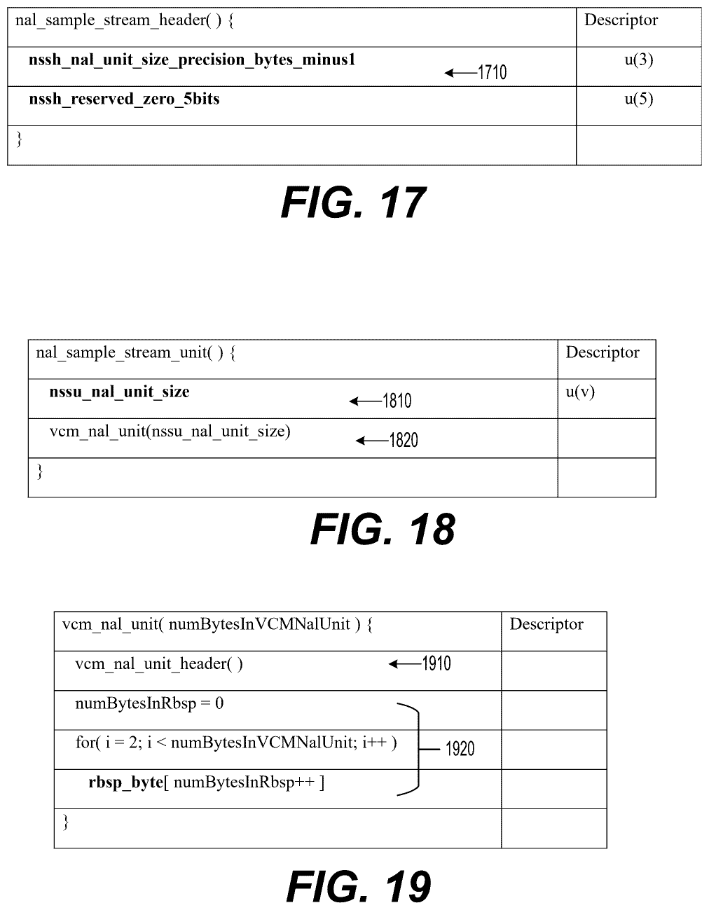

FIG. 17 shows a syntax table for a sub stream header in some examples. The sub stream header includes precision information (1710).

FIG. 18 shows a syntax table for a sub stream NAL unit in some examples. The sub stream NAL unit includes a VCM NAL unit (1820), and size information of the NAL unit (1810).

In some examples, a VCM NAL unit can include a header and raw byte sequence payload (RBSP). FIG. 19 shows a syntax table for a VCM NAL unit in some examples. The VCM NAL unit includes a header (1910), and a portion for RBSP as shown by (1920).

It is noted that the RBSP in a VCM NAL unit can be sequence restoration data RBSP, picture restoration data RB SP, and the like.

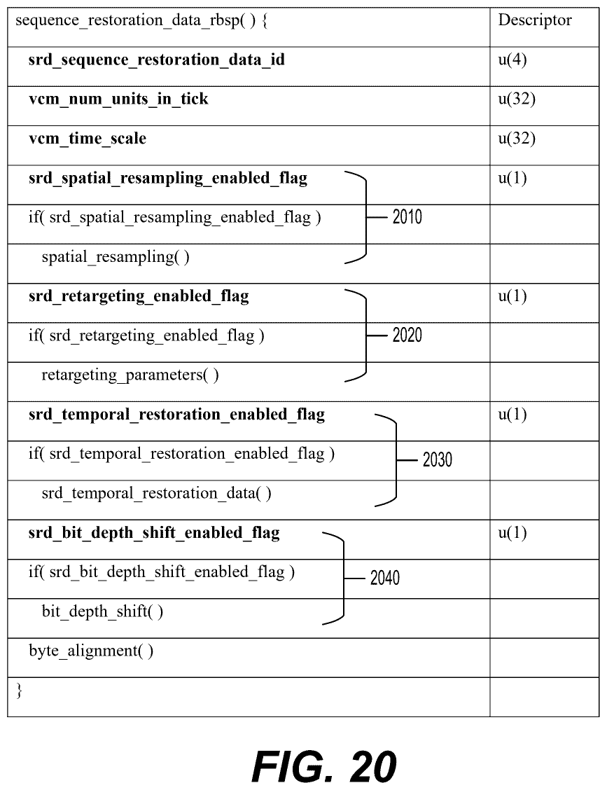

FIG. 20 shows a syntax table for sequence restoration data RBSP in some examples. In the FIG. 20 example, when a spatial resampling enabled flag at the sequence restoration data (e.g., srd_spatial_resampling_enabled_flag) is true, spatial resampling information can be extracted from the sequence restoration data RB SP, such as shown by (2010).

Also shown in the FIG. 20 example, when a retargeting enabled flag at the sequence restoration data (e.g., srd_retargeting_enabled_flag) is true, retargeting parameters can be extracted from the sequence restoration data RB SP, such as shown by (2020).

Also the FIG. 20 example, when a temporal restoration enabled flag at the sequence restoration data (e.g., srd_temporal_restoration_enabled_flag) is true, temporal restoration information can be extracted from the sequence restoration data RBSP, such as shown by (2030).

Also the FIG. 20 example, when a bit depth shift enabled flag at the sequence restoration data (e.g., srd_bit_depth_shift_enabled_flag) is true, bit depth shift information can be extracted from the sequence restoration data RBSP, such as shown by (2040).

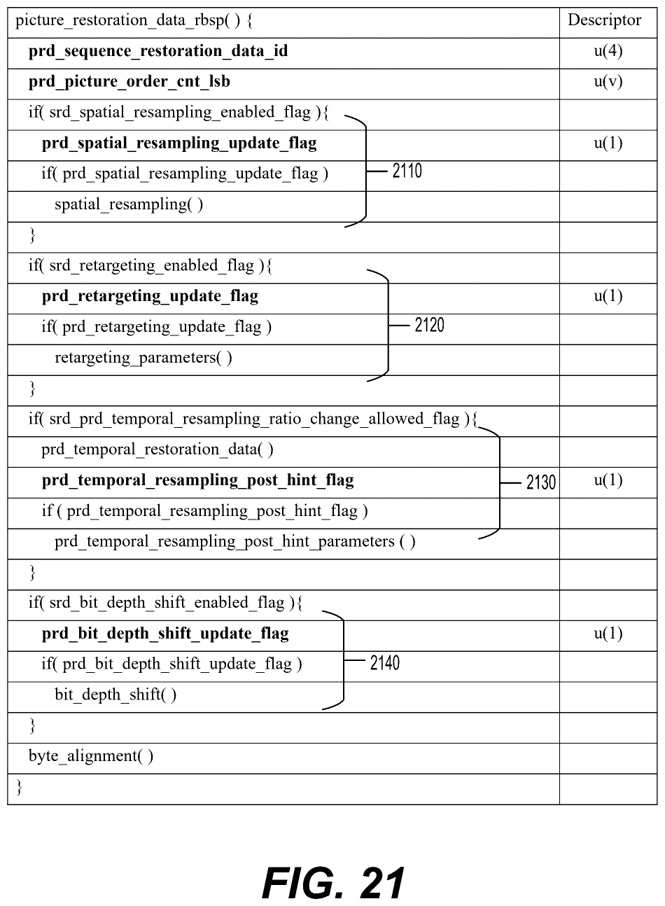

FIG. 21 shows a syntax table for picture restoration data RBSP in some examples.

In the FIG. 21 example, when a spatial resampling update flag at the picture restoration data (e.g., prd_spatial_resampling_update_flag) is true, spatial resampling information can be extracted from the picture restoration data RBSP, such as shown by (2110).

Also the FIG. 21 example, when a retargeting update flag at the picture restoration data (e.g., prd_retargeting_update_flag) is true, retargeting parameters can be extracted from the picture restoration data RBSP, such as shown by (2120).

Also the FIG. 21 example, temporal restoration information can be extracted from the picture restoration data RB SP, such as shown by (2130).

Also the FIG. 21 example, when a bit depth shift update flag at the picture restoration data (e.g., prd_bit_depth_shift_update_flag) is true, bit depth shift information can be extracted from the picture restoration data RBSP, such as shown by (2140).

It is noted that, in some examples, the picture restoration data RB SP can include a picture order count (POC) of a picture for applying the picture restoration data in the picture restoration data RBSP. For example, the POC indicates a picture decoded from the bitstream of the related video coding standard, such as the sub stream (950) in FIG. 9.

It is also noted that the restoration data can be included in the bitstream by other suitable techniques. For example, the restoration data can be included in SEI message(s). In another example, an end of restoration data RB SP container is used to include the restoration data that are useful for a restoration of the last portion of the VCM video.

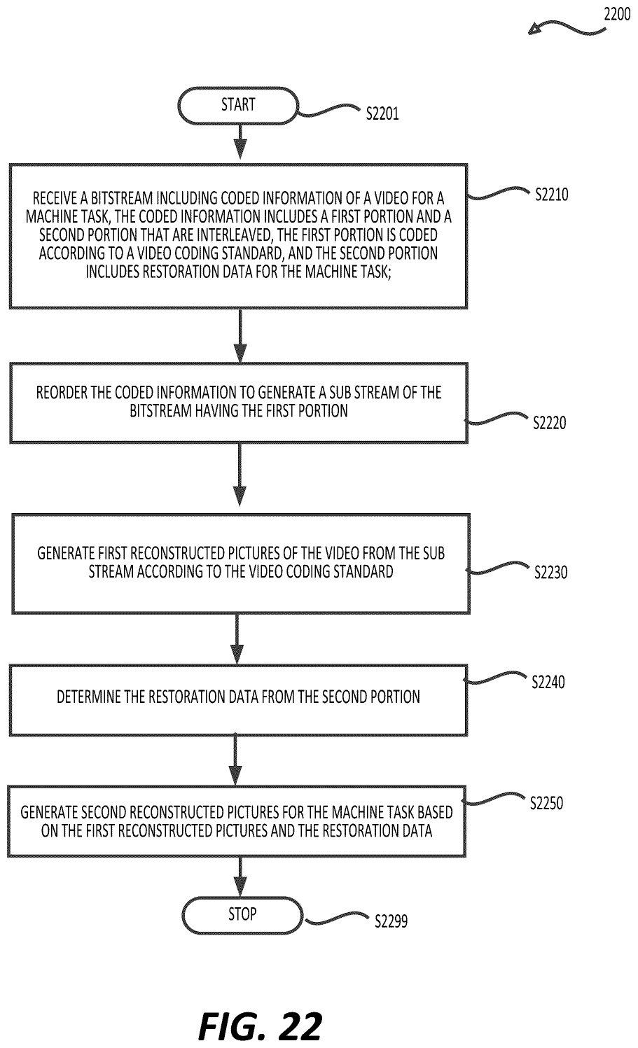

FIG. 22 shows a flow chart outlining a process (2200) according to an aspect of the disclosure. The process (2200) can be used in a video decoder. In various aspects, the process (2200) is executed by processing circuitry, such as the processing circuitry that performs functions of the video decoder (110), the processing circuitry that performs functions of the video decoder (210), and the like. In some aspects, the process (2200) is implemented in software instructions, thus when the processing circuitry executes the software instructions, the processing circuitry performs the process (2200). The process starts at (S2201) and proceeds to (S2210).

At (S2210), a bitstream is received. The bitstream includes coded information of a video for a machine task, the coded information includes a first portion and a second portion that are interleaved, the first portion is coded according to a video coding standard, and the second portion includes restoration data for the machine task.

At (S2220), the coded information is reordered to generate a sub stream of the bitstream having the first portion.

At (S2230), first reconstructed pictures of the video are generated from the sub stream according to the video coding standard.

At (S2240), the restoration data is determined from the second portion.

At (S2250), second reconstructed pictures for the machine task are generated based on the first reconstructed pictures and the restoration data.

In some aspects, the video coding standard includes at least one of: audio video standard (AVS) 1, AVS 2, AVS 3, AVS 4, advanced video coding (AVC), high efficiency video coding (HEVC), versatile video coding (VVC), alliance for open media (AOMedia) video 1 (AV1), and AV 2.

In some examples, to determine the restoration data, at least one of sequence level restoration data and/or picture level restoration data is parsed from the second portion. In some examples, one or more supplemental enhancement information (SEI) messages are parsed to obtain the restoration data.

In some examples, an extension to a structure of the video coding standard is detected. The restoration data is obtained from the extension of the structure. The structure of the video coding standard includes at least one of a sequence parameter set (SPS), a picture parameter set (PPS), a picture header (PH) and a slice header (SH).

In some examples, the restoration data includes at least one of spatial resampling parameters, retargeting parameters, temporal restoration parameters, and bit depth shift parameters from the second portion.

In some examples, picture level restoration data associated with a picture order count (POC) can be parsed from the second portion.

In some examples, restoration data for an end of the bitstream is parsed from the second portion.

In some examples, the first portion includes a plurality of network abstraction layer (NAL) units that are wrapped into video coding for machine (VCM) units of a coded video data (CVD) type.

In some examples, the second portion includes a plurality of network abstraction layer (NAL) units that are wrapped into video coding for machine (VCM) units of a restoration data (RSD) type. In an example, the plurality of NAL units include at least a NAL unit that includes sequence level restoration data. In another example, the plurality of NAL units include at least a NAL unit that includes picture level restoration data. In another example, the plurality of NAL units include at least a NAL unit corresponding to a supplemental enhancement information (SEI) including restoration data. In another example, the plurality of NAL units include at least a NAL unit that includes restoration data for an end of the sub stream.

Then, the process proceeds to (S2299) and terminates.

The process (2200) can be suitably adapted. Step(s) in the process (2200) can be modified and/or omitted. Additional step(s) can be added. Any suitable order of implementation can be used.

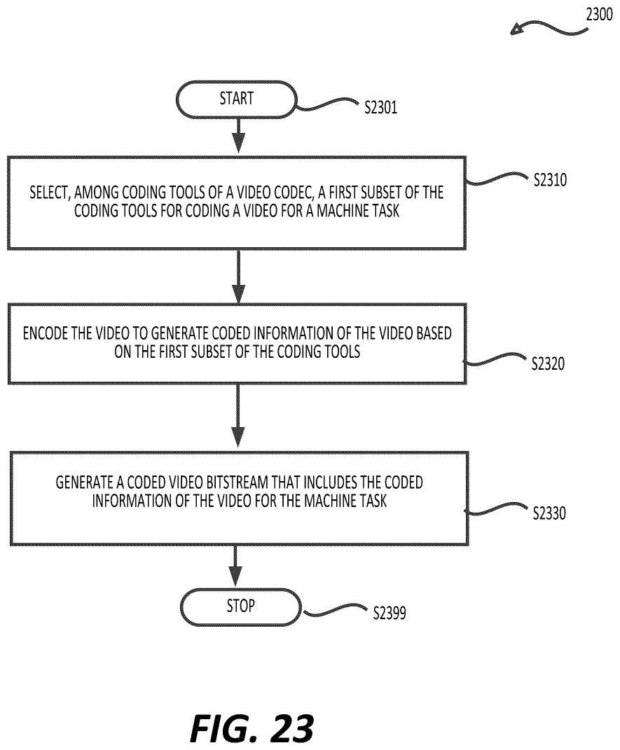

FIG. 23 shows a flow chart outlining a process (2300) according to an aspect of the disclosure. The process (2300) can be used in a video encoder. In various aspects, the process (2300) is executed by processing circuitry, such as the processing circuitry that performs functions of the video encoder (103), the processing circuitry that performs functions of the video encoder (303), and the like. In some aspects, the process (2300) is implemented in software instructions, thus when the processing circuitry executes the software instructions, the processing circuitry performs the process (2300). The process starts at (S2301) and proceeds to (S2310).

At (S2310), coded information of a video is generated according to a video coding standard.

At (S2320), restoration data for generating reconstructed pictures for a machine task from the coded information of the video is determined.

At (S2330), the coded information of the video is interleaved with the restoration data to form a bitstream.

In some aspects, the video coding standard includes at least one of: audio video standard (AVS) 1, AVS 2, AVS 3, AVS 4, advanced video coding (AVC), high efficiency video coding (HEVC), versatile video coding (VVC), alliance for open media (AOMedia) video 1 (AV 1), and AV 2.

In some examples, the restoration data comprises at least one of sequence level restoration data and/or picture level restoration data.

In some examples, the bitstream comprises a plurality of video coding for machine (VCM) units that are respectively of one of a coded video data (CVD) type, a restoration data (RSD) type and a VCM parameter set (VPS) type.

In some examples, the restoration data is included in supplemental enhancement information (SEI) messages.

In some aspects, the restoration data is included in an extension to a structure of the video coding standard. In some examples, the structure of the video coding standard comprises at least one of a sequence parameter set (SPS), a picture parameter set (PPS), a picture header (PH) and a slice header (SH).

In some examples, the restoration data includes at least one of spatial resampling parameters, retargeting parameters, temporal restoration parameters, and bit depth shift parameters from the second portion.

In some examples, picture level restoration data is associated with a picture order count (POC).

In some examples, the restoration data includes restoration data for an end of the bitstream from the second portion.

In some examples, the coded information of the video includes a plurality of network abstraction layer (NAL) units that are wrapped into video coding for machine (VCM) units of a coded video data (CVD) type.

In some examples, the restoration data includes a plurality of network abstraction layer (NAL) units that are wrapped into video coding for machine (VCM) units of a restoration data (RSD) type. In an example, the plurality of NAL units include at least a NAL unit that includes sequence level restoration data. In another example, the plurality of NAL units include at least a NAL unit that includes picture level restoration data. In another example, the plurality of NAL units include at least a NAL unit corresponding to a supplemental enhancement information (SEI) including restoration data. In another example, the plurality of NAL units include at least a NAL unit that includes restoration data for an end of the bitstream.

Then, the process proceeds to (S2399) and terminates.

The process (2300) can be suitably adapted. Step(s) in the process (2300) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a video for a machine task, the coded information includes a first portion and a second portion that are interleaved, the first portion is coded according to a video coding standard, and the second portion includes restoration data for the machine task. The format rule specifies that: the coded information is reordered to generate a sub stream of the bitstream having the first portion; first reconstructed pictures are generated from the sub stream according to the video coding standard; the restoration data is determined from the second portion; and second reconstructed pictures are generated for the machine task based on the first reconstructed pictures and the restoration data.

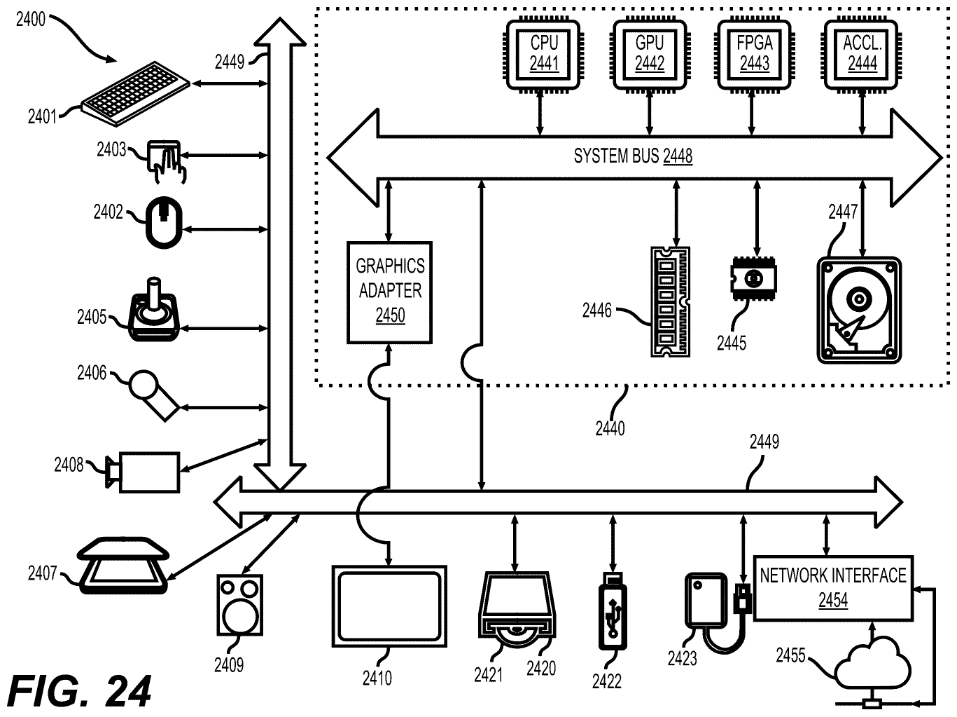

The techniques described above, can be implemented as computer software using computer-readable instructions and physically stored in one or more computer-readable media. For example, FIG. 24 shows a computer system (2400) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 24 for computer system (2400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (2400).

Computer system (2400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2401), mouse (2402), trackpad (2403), touch screen (2410), data-glove (not shown), joystick (2405), microphone (2406), scanner (2407), camera (2408).

Computer system (2400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2410), data-glove (not shown), or joystick (2405), but there can also be tactile feedback devices that do not serve as input devices), audio output devices (such as: speakers (2409), headphones (not depicted)), visual output devices (such as screens (2410) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (2400) can also include human accessible storage devices and their associated media such as optical media including CD/DVD ROM/RW (2420) with CD/DVD or the like media (2421), thumb-drive (2422), removable hard drive or solid state drive (2423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2400) can also include an interface (2454) to one or more communication networks (2455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CAN Bus, and so forth. Certain networks commonly require external network interface adapters that attached to certain general purpose data ports or peripheral buses (2449) (such as, for example USB ports of the computer system (2400)); others are commonly integrated into the core of the computer system (2400) by attachment to a system bus as described below (for example Ethernet interface into a PC computer system or cellular network interface into a smartphone computer system). Using any of these networks, computer system (2400) can communicate with other entities. Such communication can be uni-directional, receive only (for example, broadcast TV), uni-directional send-only (for example CAN bus to certain CANbus devices), or bi-directional, for example to other computer systems using local or wide area digital networks. Certain protocols and protocol stacks can be used on each of those networks and network interfaces as described above.

A forementioned human interface devices, human-accessible storage devices, and network interfaces can be attached to a core (2440) of the computer system (2400).

The core (2440) can include one or more Central Processing Units (CPU) (2441), Graphics Processing Units (GPU) (2442), specialized programmable processing units in the form of Field Programmable Gate Areas (FPGA) (2443), hardware accelerators for certain tasks (2444), graphics adapters (2450), and so forth. These devices, along with Read-only memory (ROM) (2445), Random-access memory (2446), internal mass storage such as internal non-user accessible hard drives, SSDs, and the like (2447), may be connected through a system bus (2448). In some computer systems, the system bus (2448) can be accessible in the form of one or more physical plugs to enable extensions by additional CPUs, GPU, and the like. The peripheral devices can be attached either directly to the core's system bus (2448), or through a peripheral bus (2449). In an example, the screen (2410) can be connected to the graphics adapter (2450). Architectures for a peripheral bus include PCI, USB, and the like.

CPUs (2441), GPUs (2442), FPGAs (2443), and accelerators (2444) can execute certain instructions that, in combination, can make up the aforementioned computer code. That computer code can be stored in ROM (2445) or RAM (2446). Transitional data can also be stored in RAM (2446), whereas permanent data can be stored for example, in the internal mass storage (2447). Fast storage and retrieve to any of the memory devices can be enabled through the use of cache memory, that can be closely associated with one or more CPU (2441), GPU (2442), mass storage (2447), ROM (2445), RAM (2446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2400), and specifically the core (2440) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2440) that are of non-transitory nature, such as core-internal mass storage (2447) or ROM (2445). The software implementing various aspects of the present disclosure can be stored in such devices and executed by core (2440). A computer-readable medium can include one or more memory devices or chips, according to particular needs. The software can cause the core (2440) and specifically the processors therein (including CPU, GPU, FPGA, and the like) to execute particular processes or particular parts of particular processes described herein, including defining data structures stored in RAM (2446) and modifying such data structures according to the processes defined by the software. In addition or as an alternative, the computer system can provide functionality as a result of logic hardwired or otherwise embodied in a circuit (for example: accelerator (2444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of video decoding, including: receiving a bitstream including coded information of a video for a machine task, the coded information including a first portion and a second portion that are interleaved, the first portion being coded according to a video coding standard, and the second portion including restoration data for the machine task; reordering the coded information to generate a sub stream of the bitstream having the first portion; generating first reconstructed pictures of the video from the sub stream according to the video coding standard; determining the restoration data from the second portion; and generating second reconstructed pictures for the machine task based on the first reconstructed pictures and the restoration data.

(2). The method of feature (1), in which the video coding standard includes at least one of: audio video standard (AVS) 1, AVS (2), AVS 3, AVS 4, advanced video coding (AVC), high efficiency video coding (HEVC), versatile video coding (VVC), alliance for open media (AOMedia) video 1 (AV1), and AV (2).

(3). The method of any of features (1) to (2), in which the determining the restoration data includes at least one of: parsing sequence level restoration data from the second portion; and parsing picture level restoration data from the second portion.

(4). The method of any of features (1) to (3), in which the determining the restoration data includes: parsing one or more supplemental enhancement information (SEI) messages to obtain the restoration data.

(5). The method of any of features (1) to (4), in which the determining the restoration data includes: detecting an extension to a structure of the video coding standard; and obtaining the restoration data from the extension of the structure.

(6). The method of any of features (1) to (5), in which the structure of the video coding standard includes at least one of a sequence parameter set (SPS), a picture parameter set (PPS), a picture header (PH) and a slice header (SH).

(7). The method of any of features (1) to (6), in which the determining the restoration data includes: determining at least one of spatial resampling parameters, retargeting parameters, temporal restoration parameters, and bit depth shift parameters from the second portion.

(8). The method of any of features (1) to (7), in which the determining the restoration data includes: parsing picture level restoration data associated with a picture order count (POC) from the second portion.

(9). The method of any of features (1) to (8), in which the determining the restoration data includes: parsing restoration data for an end of the bitstream from the second portion.

(10). The method of any of features (1) to (9), in which the first portion includes a plurality of network abstraction layer (NAL) units that are wrapped into video coding for machine (VCM) units of a coded video data (CVD) type.

(11). The method of any of features (1) to (10), in which the second portion includes a plurality of network abstraction layer (NAL) units that are wrapped into video coding for machine (VCM) units of a restoration data (RSD) type.

(12). The method of any of features (1) to (11), in which the plurality of NAL units include at least a NAL unit that includes sequence level restoration data.

(13). The method of any of features (1) to (12), in which the plurality of NAL units include at least a NAL unit that includes picture level restoration data.

(14). The method of any of features (1) to (13), in which the plurality of NAL units include at least a NAL unit corresponding to a supplemental enhancement information (SEI) including restoration data.

(15). The method of any of features (1) to (14), in which the plurality of NAL units include at least a NAL unit that includes restoration data for an end of the sub stream of the first portion.

(16). A method of video encoding, including: generating coded information of a video according to a video coding standard; determining restoration data for generating reconstructed pictures for a machine task from the coded information of the video; and interleaving the coded information of the video with the restoration data to form a bitstream.

(17). The method of feature (16), in which the video coding standard includes at least one of: audio video standard (AVS) 1, AVS 2, AVS 3, AVS 4, advanced video coding (AVC), high efficiency video coding (HEVC), versatile video coding (VVC), alliance for open media (AOMedia) video 1 (AV1), and AV 2.

(18). The method of any of features (16) to (17), in which the restoration data includes at least one of sequence level restoration data and/or picture level restoration data.

(19). The method of any of features (16) to (18), in which the bitstream includes a plurality of video coding for machine (VCM) units that are respectively of one of a coded video data (CVD) type, a restoration data (RSD) type and a VCM parameter set (VPS) type.

(20). The method of any of features (16) to (19), in which the restoration data is included in supplemental enhancement information (SEI) messages.

(21). The method of any of features (16) to (20), in which the restoration data is included in an extension to a structure of the video coding standard.

(22). The method of any of features (16) to (21), in which the structure of the video coding standard includes at least one of a sequence parameter set (SPS), a picture parameter set (PPS), a picture header (PH) and a slice header (SH).

(23). The method of any of features (16) to (22), in which the restoration data includes at least one of spatial resampling parameters, retargeting parameters, temporal restoration parameters, and bit depth shift parameters.

(24). The method of any of features (16) to (23), in which picture level restoration data is associated with a picture order count (POC).

(25). The method of any of features (16) to (24), in which the restoration data includes restoration data for an end of the bitstream.

(26). The method of any of features (16) to (25), in which the coded information of the video includes a plurality of network abstraction layer (NAL) units that are wrapped into video coding for machine (VCM) units of a coded video data (CVD) type.

(27). The method of any of features (16) to (26), in which the restoration data includes a plurality of network abstraction layer (NAL) units that are wrapped into video coding for machine (VCM) units of a restoration data (RSD) type.

(28). The method of any of features (16) to (27), in which the plurality of NAL units include at least a NAL unit that includes sequence level restoration data.

(29). The method of any of features (16) to (28), in which the plurality of NAL units include at least a NAL unit that includes picture level restoration data.

(30). The method of any of features (16) to (29), in which the plurality of NAL units include at least a NAL unit corresponding to a supplemental enhancement information (SEI) including restoration data.

(31). The method of any of features (16) to (30), in which the plurality of NAL units include at least a NAL unit that includes restoration data for an end of the bitstream.

(32). A method of processing visual media data, the method including: processing a bitstream that includes the visual media data according to a format rule, in which: the bitstream carries coded information of a video for a machine task, the coded information including a first portion and a second portion that are interleaved, the first portion being coded according to a video coding standard, and the second portion including restoration data for the machine task; and the format rule specifies that: the coded information is reordered to generate a sub stream of the bitstream having the first portion; first reconstructed pictures are generated from the sub stream according to the video coding standard; the restoration data is determined from the second portion; and second reconstructed pictures are generated for the machine task based on the first reconstructed pictures and the restoration data.

(33). An apparatus for video decoding, including processing circuitry that is configured to perform the method of any of features (1) to (15).

(34). An apparatus for video encoding, including processing circuitry that is configured to perform the method of any of features (16) to (31).

(35). A non-transitory computer-readable storage medium storing instructions which when executed by at least one processor cause the at least one processor to perform the method of any of features (1) to (32).

What is claimed is:

1. A method of video decoding, comprising:
receiving a bitstream comprising coded information of a video for a machine task, the coded information comprising a first portion and a second portion that are interleaved, the first portion being coded according to a video coding standard, and the second portion comprising restoration data for the machine task;
reordering the coded information to generate a sub stream of the bitstream having the first portion;
generating first reconstructed pictures of the video from the sub stream according to the video coding standard;
determining the restoration data from the second portion; and
generating second reconstructed pictures for the machine task based on the first reconstructed pictures and the restoration data.

2. The method of claim 1, wherein the video coding standard comprises at least one of: audio video standard (AVS) 1, AVS 2, AVS 3, AVS 4, advanced video coding (AVC), high efficiency video coding (HEV C), versatile video coding (VVC), alliance for open media (AOMedia) video 1 (AV1), and AV 2.

3. The method of claim 1, wherein the determining the restoration data comprises at least one of:
parsing sequence level restoration data from the second portion; and
parsing picture level restoration data from the second portion.

4. The method of claim 1, wherein the determining the restoration data comprises:
parsing one or more supplemental enhancement information (SEI) messages to obtain the restoration data.

5. The method of claim 1, wherein the determining the restoration data comprises:
detecting an extension to a structure of the video coding standard; and
obtaining the restoration data from the extension of the structure.

6. The method of claim 5, wherein the structure of the video coding standard comprises at least one of a sequence parameter set (SPS), a picture parameter set (PPS), a picture header (PH) and a slice header (SH).

7. The method of claim 1, wherein the determining the restoration data comprises:
determining at least one of spatial resampling parameters, retargeting parameters, temporal restoration parameters, and bit depth shift parameters from the second portion.

8. The method of claim 1, wherein the determining the restoration data comprises:
parsing picture level restoration data associated with a picture order count (POC) from the second portion.

9. The method of claim 1, wherein the determining the restoration data comprises:
parsing restoration data for an end of the bitstream from the second portion.

10. The method of claim 1, wherein the first portion comprises a plurality of network abstraction layer (NAL) units that are wrapped into video coding for machine (VCM) units of a coded video data (CVD) type.

11. The method of claim 1, wherein the second portion comprises a plurality of network abstraction layer (NAL) units that are wrapped into video coding for machine (VCM) units of a restoration data (RSD) type.

12. The method of claim 11, wherein the plurality of NAL units include at least a NAL unit that includes sequence level restoration data.

13. The method of claim 11, wherein the plurality of NAL units include at least a NAL unit that includes picture level restoration data.

14. The method of claim 11, wherein the plurality of NAL units include at least a NAL unit corresponding to a supplemental enhancement information (SEI) including restoration data.

15. The method of claim 11, wherein the plurality of NAL units include at least a NAL unit that includes restoration data for an end of the sub stream of the first portion.

16. A method of video encoding, comprising:
generating coded information of a video according to a video coding standard;
determining restoration data for generating reconstructed pictures for a machine task from the coded information of the video; and
interleaving the coded information of the video with the restoration data to form a bitstream.

17. The method of claim 16, wherein the video coding standard comprises at least one of: audio video standard (AVS) 1, AVS 2, AVS 3, AVS 4, advanced video coding (AVC), high efficiency video coding (HEV C), versatile video coding (VVC), alliance for open media (AOMedia) video 1 (AV1), and AV 2.

18. The method of claim 16, wherein the restoration data comprises at least one of sequence level restoration data and/or picture level restoration data.

19. The method of claim 16, wherein the bitstream comprises a plurality of video coding for machine (VCM) units that are respectively of one of a coded video data (CVD) type, a restoration data (RSD) type and a VCM parameter set (VPS) type.

20. A method of processing visual media data, the method comprising:
processing a bitstream that includes the visual media data according to a format rule, wherein:
the bitstream carries coded information of a video for a machine task, the coded information comprising a first portion and a second portion that are interleaved, the first portion being coded according to a video coding standard, and the second portion comprising restoration data for the machine task; and
the format rule specifies that:
the coded information is reordered to generate a sub stream of the bitstream having the first portion;
first reconstructed pictures are generated from the sub stream according to the video coding standard;
the restoration data is determined from the second portion; and
second reconstructed pictures are generated for the machine task based on the first reconstructed pictures and the restoration data.
